(19) United States
(12) Patent Application Publication
(10) Pub. No.: US 2009/0261265 A1
(43) Pub. Date: Oct. 22, 2009

(54) APPARATUS AND METHOD FOR ARRAY GEM DIGITAL IMAGING RADIATION DETECTOR

(75) Inventors: Chang Hie Hahn, Gyeongsangnam-do (KR); Ii-Gon Kim, Gyeongsangnam-do (KR); Seongtae Park, Gyeongsangnam-do (KR); Jaehoon Yu, Arlington, TX (US)

Correspondence Address: LRK Patent Firm, 1952 Gallows Rd Suite 200, Vienna, VA, 22182, US

(73) Assignee: Chang Hie HAHN, Gyeongsangnam-do (KR)

(21) Appl. No.: 12/097,755

(22) PCT Filed: Feb. 24, 2006
(86) PCT No.: PCT/KR06/00662

§ 371 Date: Apr. 2, 2009

(30) Foreign Application Priority Data
Dec. 16, 2005 (KR) 10-2005-0124266

(51) Int. Cl. H01J 47/00; G01N 23/04

(52) U.S. Cl. 250/375; 250/382

(57) ABSTRACT

An array gas electron multiplier (GEM) digital imaging radiation detector and a control method thereof are disclosed. The array gas electron multiplier (GEM) digital imaging radiation detector includes an array GEM detector. The array GEM detector includes: an ionized electron generation unit for generating ionized electrons in internal filling gas by incident X-rays or gamma rays or by incident charged particles; a gas electron multiplication unit for multiplying the ionized electrons of the ionized electron generation unit in filling gas inside hole of a gas electron multiplier (GEM), through electron avalanche effect, using the GEM, to form electron clouds; a readout for detecting and outputting coordinates of the electron clouds as the readout receives positions through electrical signals, in which the positions of the electron clouds, being multiplied and formed in the gas electron multiplication unit, reach output electrodes. Therefore, the present invention can multiply ionized electrons of internal filling gas as a gas electron multiplier (GEM) generates an electron avalanche effect in the hole thereof, in which the ionized electrons are generated as a photo-electron effect or a Compton effect is induced by high energy incident light, such as X-rays or gamma rays, or which are directly generated by incident charged particles, and can convert image information of the inside or outside of an target object into images of two-dimensions, in real time, such that the detector can be properly used as a security search apparatus in a harbor or an airport, or can be adapted as a core part of industrial nondestructive testing apparatus.

### CROSS-REFERENCES TO RELATED APPLICATIONS

This is a U.S. national stage of International Application PCT/KR2006/000662 filed Feb. 24, 2006, further claiming the benefit of priority of Republic of Korea application 10-2005-0124266, filed Dec. 16, 2005. Each of the aforementioned applications is incorporated by reference herein.

### INTRODUCTION

The present invention relates to a radiation detector, and, more particularly, to an array GEM digital imaging radiation detector and a control method thereof, which are capable of multiplying ionized electrons of internal filling gas as a gas electron multiplier (GEM) generates an electron avalanche in the hole thereof, in which the ionized electrons are generated as a photo-electron effect or a Compton effect is induced by high energy incident light, such as X-rays or gamma rays, or which are directly generated by incident charged particles, and of converting image information of the inside or outside of a target object into images of two-dimensions, in real time, such that the detector can be properly used as a security search apparatus in a harbor or an airport, or can be adapted as a core part of an industrial nondestructive testing apparatus.

### BACKGROUND

Generally, a technology of gas electron multiplication was developed by Dr. F. Sauli and Dr. R. D. Oliveira, et al . at Gas Detector Development Group in CERN in order to detect high-energy charged particles in 1997. Since the technology was determined to have various potential applications, international advance research groups have variously studied the technology. However, the studies related to its applications are in an initial stage.

Especially, gas can show a photoelectron effect and a Compton effect by X-rays and gamma rays having a few of keV to hundreds of keV. Since a gas electron multiplier (GEM) detector has better position and time resolutions, a high definition imaging technology for medical instruments, which is capable of real-time x-raying a target object, has been rapidly researched such that radiography of X-rays can be performed on the basis of a GEM technology.

Such a GEM detector has advantages in that its manufacturing cost is low, its safety is high, its weight is light, its thickness is thin, and its flexibility is large, etc. Also, since the GEM detector serves to detect X-rays or gamma rays or charged particles as gases are ionized, it can overcome drawbacks of a charged coupled device (CCD) which has a relatively high operation efficiency only in the visible light range. In addition, the GEM detector has various applications such that it can effectively measure charged particles, and it can detect neutrons as BF₃ is added to gases in its inside or a GEM foil is coated with a neutron stopping material, such as Boron.

Therefore, the GEM detector is now applied to various applications, such as, a medical X-ray real time imaging device, an industrial non-destructive testing apparatus, an X-ray astronomical telescope, an X-ray microscope, an X-ray polarizer, a plasma diagnostic controller, and a radiation detector, etc.

However, since researches related to applications of the GEM detector are still in an initial stage, there is no known technology which is capable of multiplying ionized electrons of internal filling gas as a gas electron multiplier (GEM) generates an electron avalanche in the hole thereof, in which the ionized electrons are generated as a photo-electron effect or a Compton effect is induced by high energy incident light, such as X-rays or gamma rays, or which are directly generated by incident charged particles, and of converting image information of the inside or outside for planar or perspective form of a target object into digital images, in real-time.

### SUMMARY

Therefore, the present invention has been made in view of the above problems, and it is an object of the present invention to provide an array GEM digital imaging radiation detector and a control method thereof, which are capable of multiplying ionized electrons of internal filling gas as a gas electron multiplier (GEM) generates an electron avalanche in the hole thereof, in which the ionized electrons are generated as a photo-electron effect or a Compton effect is induced by high energy incident lights, such as X-rays or gamma rays, or which are directly generated by incident charged particles, and of converting image information of the inside or outside of a target object into images of two-dimensions, in real time, such that the detector can be properly used as a security search apparatus in a harbor or an airport, or can be adapted as a core part of an industrial nondestructive testing apparatus.

In accordance with an aspect of the present invention, the above and other objects can be accomplished by the provision of an array gas electron multiplier (GEM) digital imaging radiation detector comprising an array GEM detector. Here, the array GEM detector includes: an ionized electron generation unit for generating ionized electrons in internal filling gas by incident X-rays or gamma rays or for directly generating ionized electrons in internal filling gas by incident charged particles; a gas electron multiplication unit for multiplying the ionized electrons of the ionized electron generation unit in filling gas inside hole of a gas electron multiplier (GEM), through electron avalanche effect, using the GEM, to form electron clouds; and a readout for detecting and outputting coordinates of the electron clouds as the readout receives positions through electrical signals, in which the positions of the electron clouds, being multiplied and formed in the gas electron multiplication unit, reach output electrodes.

In accordance with another aspect of the present invention, there is provided to a method of controlling an array GEM digital imaging radiation detector includes: a first step which is performed such that, when X-rays or gamma rays or charged particles are projected to a target object which is translated by a translation unit, the X-rays or gamma rays, which are projected to the cathode of the ionized electron generation unit or a drift-acceleration region, are converted into photo-electrons or Compton electrons, and ionized electrons are generated in gases in the drift-acceleration region using the converted photo-electrons or Compton electrons, or ionized electrons are directly generated in gases in the drift-acceleration region using incident charged particles; a second step which is performed such that the ionized electrons generated in the first step are accelerated and amplified in internal filling gases of a hole of a gas electron multiplier through an electron avalanche effect to form electron clouds, and signals of the electron clouds are extracted; and a third step which is performed such that the extracted signals of the second step are analyzed, and then image information of the inside and outside of the target object is outputted thereto in a planar image format.

As described below, the array GEM digital imaging radiation detector and the control method thereof according to the present invention can multiply ionized electrons of internal filling gas as a gas electron multiplier (GEM) generates an electron avalanche in the hole thereof, in which the ionized electrons are generated as a photo-electron effect or a Compton effect is induced by high energy incident light, such as X-rays or gamma rays, or which are directly generated by incident charged particles, and can convert image information of the inside or outside of an target object into images of two-dimensions, in real time, such that the detector can be properly used as a security search apparatus in a harbor or an airport, or can be adapted as a core part of an industrial nondestructive testing apparatus.

Also, although the GEM detector according to the present invention does not use a tube and a dynode because of use of an MPCB, it has advantages in that its performance is superior to the conventional products, its thickness is thin, and its usage is convenient, such that it can be a next generation light-thin-simple-small radiation detector in the fields of array detectors for detecting X-rays or gamma rays and charged particle beams, whose industrial demands are increased.

Further, the GEM detector according to the present invention can create high value-added effect as it can be applied to applications, such as an medical X-ray real time imaging apparatus, and an industrial non-destructive testing apparatus.

In addition, the array GEM digital imaging radiation detector according to the present invention has advantages in that it has a spatial resolution which is similar to that of the CCD and a good time resolution of a few nanosecond, while the CCD has difficulty to detect X-rays or gamma rays although it has a good ability to detect visible light.

Furthermore, although the conventional security search apparatus using X-rays or gamma rays, which is commercially sold, is implemented using silicon, germanium or scintillator, etc., each of such type of apparatus has disadvantages in that it has physical characteristics decreasing detection efficiency when high energy photons are measured, it requires a cooling apparatus such that it can be operated at a room temperature, it has a difficulty to increase a position resolution, and its cannot be largely manufactured. On the other hand, the present invention has advantages in that it can be relatively easily and cost-effectively manufactured, and also its size and form can be freely changed. Also, since the present invention can detect photons and charged particles, which are in various ranges of energy bands, the present invention can be further developed for various fields and, as detector manufacture and output technologies are added thereto, its market can be expanded in the future. Additionally, the cost-effectiveness and performance of the present invention are superior to the conventional products.

### BRIEF DESCRIPTION OF THE DRAWINGS

FIG. 1 illustrates a block diagram of an array GEM digital imaging radiation detector according to one embodiment of the present invention;

FIG. 2 illustrates a detailed view of an incident window of FIG. 1;

FIG. 3 illustrates a perspective view of the gas electron multiplication unit of FIG. 1;

FIG. 4 illustrates a perspective view of the array GEM detector of FIG. 1;

FIG. 5 illustrates a cross-sectional view of the array GEM detector of FIG. 1;

FIG. 6 illustrates a block diagram of the array GEM digital imaging radiation detector including the array GEM of FIG. 1;

FIG. 7 illustrates a view describing signal detection using X-rays, gamma rays or charged particle beam, which penetrates a target object when the target object is translated by a translation unit of FIG. 6;

FIG. 8 illustrates a detailed block diagram of an analysis unit of FIG. 6;

FIG. 9 illustrates a detailed block diagram of a data acquisition unit of FIG. 6;

FIG. 10 illustrates a detailed block diagram of the display unit of FIG. 6; and

FIG. 11 illustrates a flow chart describing a control method of an array GEM digital imaging radiation detector according to one embodiment of the present invention.

### DETAILED DESCRIPTION

With reference to attached drawings, preferred embodiments of an array gas electron multiplier (GEM) digital imaging radiation detector and a control method thereof according to the present invention are described in details follows.

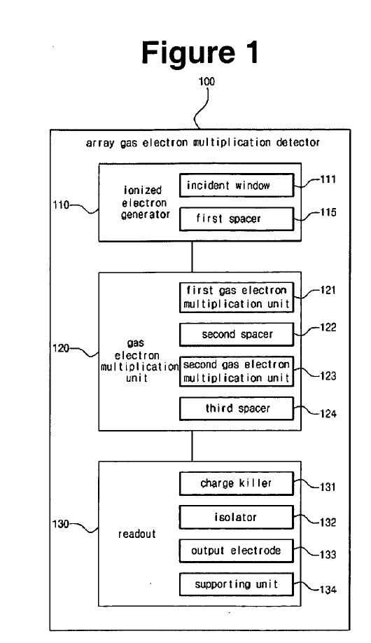

FIG. 1 illustrates a block diagram of an array GEM digital imaging radiation detector according to one embodiment of the present invention. As shown in the drawing, an array GEM detector 100 of the array GEM digital imaging radiation detector includes: an ionized electron generation unit 110 for generating ionized electrons in internal filling gas by incident X-rays or gamma rays or directly generating ionized electrons in internal filling gas by incident charged particles; a gas electron multiplication unit 120 for multiplying the ionized electrons of the ionized electron generation unit 110 in filling gas inside hole of a gas electron multiplier (GEM), through electron avalanche, using the GEM, to form electron clouds; a readout 130 for detecting and outputting coordinates of the electron clouds as the readout receives positions through electrical signals, in which the positions of the electron clouds, being multiplied and formed in the gas electron multiplication unit 120, reach output electrodes 133.

The ionized electron generation unit 110 includes: an incident window 111 which converts incident gamma rays into photoelectrons or Compton electrons or receives incident X-rays or incident charged particles; and a first spacer 115 which is located between the first window 111 and the gas electron multiplication unit 120, wherein the first spacer 115 forms a drift-acceleration region which converts the incident X-rays or gamma rays into photo-electrons or Compton electrons and generates ionized electrons in the internal filling gas using the converted photo-electrons or Compton electrons, or directly generates ionized electrons in the internal filling gas using the incident charged particles, and fills primary gas and buffer gas, which are mixed with a certain ratio, at a certain pressure therein.

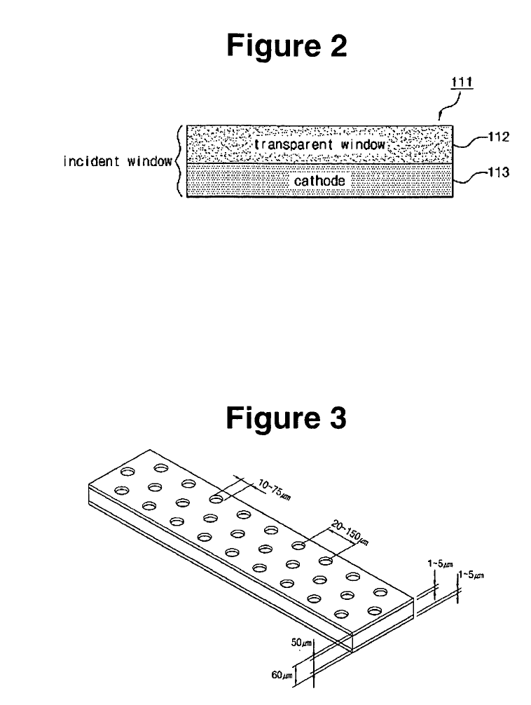

FIG. 2 illustrates a detailed view of an incident window of FIG. 1. As shown in the drawing, the incident window 111 includes a transparent window (W) 112 which can transmit or screen the incident X-rays or gamma rays according to detection objective of the incident X-rays or gamma rays and a cathode 113 coated with an electrode material such that incident radiation transmitted to the incident window 111 can reach thereto.

The cathode 113 is coated with one or more than one electrode materials of gold, aluminum, copper, silver and platinum. The cathode 113 is coated with the electrode materials at a thickness of 5˜30 μm.

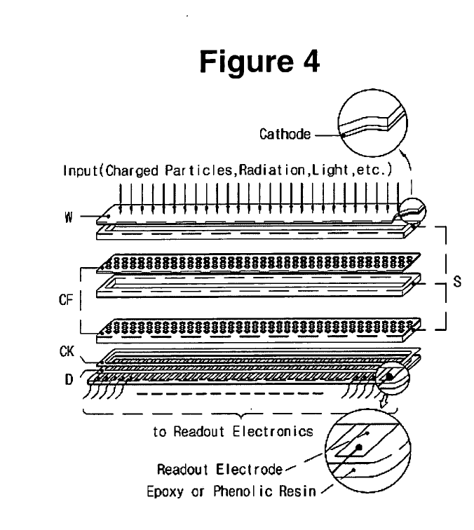

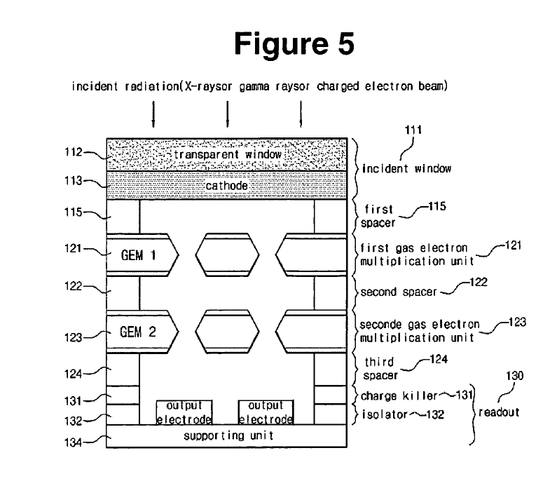

FIG. 3 illustrates a perspective view of the gas electron multiplication unit of FIG. 1. FIG. 4 illustrates a perspective view of the array GEM detector of FIG. 1. FIG. 5 illustrates a cross-sectional view of the array GEM detector of FIG. 1.

As shown in the drawings, the gas electron multiplication unit 120 includes one or more than one gas electron multipliers (GEM). More specifically, the gas electron multiplication unit 120 is implemented such that it includes: a first gas electron multiplication unit 121 which accelerates electrons ionized in gases in the drift-acceleration region, in which the ionized electrons are converted in the ionized electron generation unit 110, and multiplies the number of electrons in gases filled in the hole of the GEM with a certain ratio using an electron avalanche effect and a second spacer 122 which is located between the first gas electron multiplication unit 121 and the readout 130, such that the second spacer 122 forms an induction region and is filled with primary gas and buffer gas, which are mixed with a certain ratio, at a certain pressure therein.

Also, the gas electron multiplication unit 120 may be implemented such that it includes: a first gas electron multiplication unit 121 which accelerates electrons ionized in gases in the drift-acceleration region, in which the ionized electrons are converted in the ionized electron generation unit 110, and multiplies the number of electrons in gases filled in the hole of the GEM with a certain ratio using an electron avalanche effect a second spacer 122 which is located between the first gas electron multiplication unit 121 and a readout 130, such that the second spacer 122 forms an induction regions; a second gas electron multiplication unit 123 which re-multiplies the number of electrons, which are multiplied in the first gas electron multiplication unit 121, in gases filled in the hole of the GEM with a certain ratio using an electron avalanche effect, to form electron clouds; and a third spacer 124 which is located between the second gas electron multiplication unit 123 and a readout 130, which forms an induction region and is filled with primary gas and buffer gas, which are mixed with a certain ratio, at a certain pressure therein.

Each of the first and second gas electron multiplication units 121 and 123 includes 3˜5 holes which are aligned along the length direction.

The readout 130 includes: a charge killer 131 for removing noise except for the electron clouds multiplied in the gas electron multiplication unit 120; an isolator (D) 132 which isolates the charge killer 131 and an output electrode 133 such that a spatial region of the electron clouds can be restricted and a spatial resolution of signal can be increased; an output electrode 133 for transmitting electrical signals of the electron clouds, which pass through the charge killer 131 and the isolator 132, to the outside of the readout 130; and a supporting unit 134 for supporting the readout 133.

The charge killer 131 is coated with a single high conduction material. The charge killer 131 is coated with a single conduction material at the edge of the output electrode 133 such that noise can be removed except for the electron clouds multiplied in the gas electron multiplication unit 120. The charge killer 131 is connected to the ground.

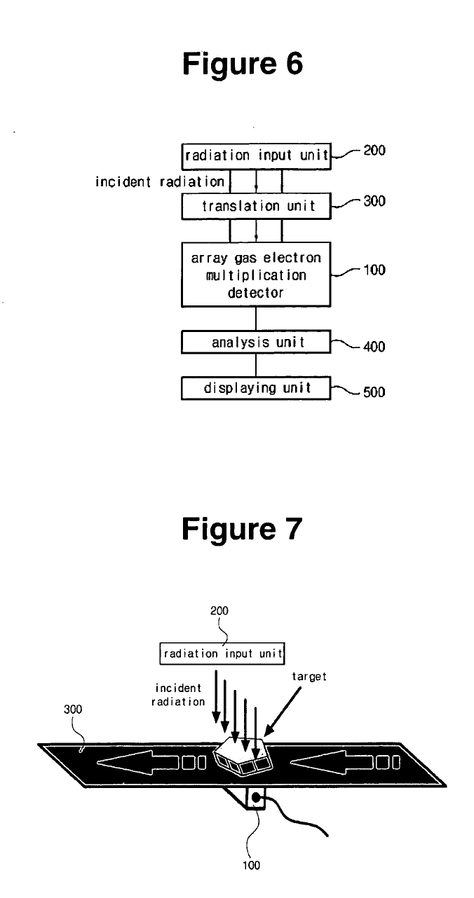

FIG. 6 illustrates a block diagram of the array GEM digital imaging radiation detector including the array GEM of FIG. 1. FIG. 7 illustrates a view describing signal detection using X-rays or gamma rays or charged particle beam, which penetrates a target object when the target object is translated by a translation unit of FIG. 6.

As shown in the drawings, the array gas electron multiplier (GEM) digital imaging radiation detector further includes: a radiation input unit 200 for projecting incident radiation, such as, X-rays or gamma rays or charged particles to a target object; and a translation unit 300 for translating the target object such that the incident radiation of the radiation input unit 200 can penetrate the target object to be transmitted to the array gas electron multiplication unit 100.

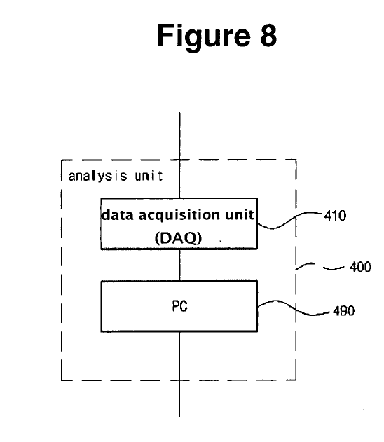

FIG. 8 illustrates a detailed block diagram of an analysis unit of FIG. 6. As shown in the drawings, the array gas electron multiplier (GEM) digital imaging radiation detector further includes: an analysis unit 400 which analyzes the electrical signals outputted from the array gas electron multiplication unit 100 and reconfigures image information of the inside and outside of the target object to form two-dimensional images. The analysis unit 400 includes: a data acquisition unit 410 which inputs and analyzes the electrical signals outputted from the array gas electron multiplication unit 100 according to magnitudes of the electrical signals, in which the data acquisition unit 410 is implemented with a Data Acquisition (DAQ) card; and a personal computer 490 which re-configures the information of the inside and outside of the target object, which is acquired in the data acquisition unit 410, to form a planar image.

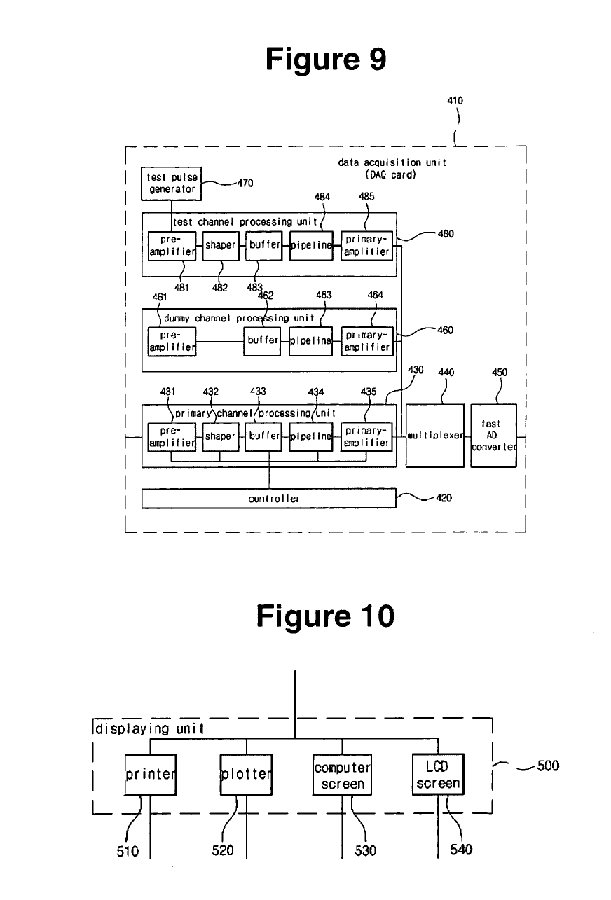

FIG. 9 illustrates a detailed block diagram of a data acquisition unit of FIG. 8. The data acquisition unit 410 is implemented such that it includes: a controller 420 for controlling operations of the data acquisition unit 410; a primary channel processing unit 430 which performs a primary channel process for the electrical signals outputted from the array gas electron multiplication unit 100, and classifies the processed electrical signals based on magnitudes of the electrical signals, detects energy distribution of incident radiation, and then outputs the result; a multiplexer 440 for multiplexing the outputs of the primary channel processing unit 430 and outputting the multiplexed result; and a fast AD converter 450 for performing analog to digital conversion for the output of the multiplexer 440 and outputting the converted result.

The primary channel processing unit 430 includes: a pre-amplifier 431 for amplifying the electrical signals outputted from the array GEM detector 100; a shaper 432 for performing reconfiguration of pulse shapes for the amplified signals of the pre-amplifier 431; a buffer 433 for storing the output of the shaper 432; a pipeline 434 for classifying the electrical signals stored in the buffer 433, detecting energy distribution of incident radiation and then outputting them; a primary-amplifier 435 for amplifying the output of the pipeline 434 to transmit it to the multiplexer 440.

The data acquisition unit 410 is implemented to further include a dummy channel processing unit 460. Here, the dummy channel processing unit 460 includes: a pre-amplifier 461 for amplifying electrical signals inputted to a dummy channel; a buffer 462 for storing the output of the pre-amplifier 461; a pipeline 463 for classifying the electrical signals stored in the buffer 462, detecting energy distribution of incident radiation and then outputting them; a primary-amplifier 464 for amplifying the output of the pipeline 463 to transmit it to the multiplexer 440.

The data acquisition unit 410 is implemented to further include a test pulse generator 470 for generating a test pulse, and a test channel processing unit 480. Here, the test channel processing unit 480 includes: a pre-amplifier 481 for inputting the test pulse from the test pulse generator 470 and amplifying it; a shaper 482 for performing reconfiguration of pulse shapes for the amplified signals of the pre-amplifier 481; a buffer 483 for storing the output of the shaper 482; a pipeline 484 for classifying the electrical signals stored in the buffer 483, detecting energy distribution of incident radiation and then outputting them; a primary-amplifier 485 for amplifying the output of the pipeline 484 and transmitting the amplified result to the multiplexer 440.

FIG. 10 illustrates a detailed block diagram of the display unit of FIG. 6. As shown in the drawing, the array gas electron multiplier (GEM) digital imaging radiation detector further includes: a displaying unit 500 for outputting image information of the inside and outside of the target object in a two-dimensional image format thereto, in which the image information is reconfigured on the basis of the signals outputted from the analysis unit 400. Here, the displaying unit 500 is implemented with one or more than one of a printer 510, a plotter 520, a computer screen 530, and an LC screen 540.

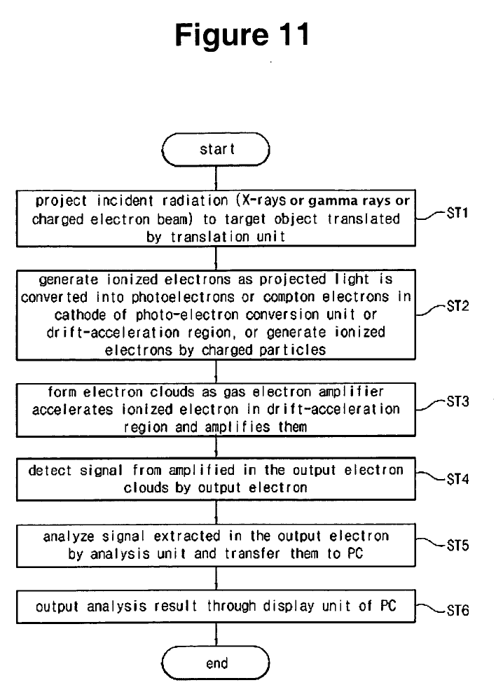

FIG. 11 illustrates a flow chart describing a control method of an array GEM digital imaging radiation detector according to one embodiment of the present invention. As shown in the drawing, the control method includes: a first step which is performed such that, when X-rays or gamma rays or charged particles are projected to a target object which is translated by a translation unit 300, in step ST1, the X-rays or gamma rays, which are projected to a cathode 113 of the ionized electron generation unit 110 or a drift-acceleration region, is converted into photo-electrons or Compton electrons, and ionized electrons are generated in gases in the drift-acceleration region using the converted photo-electrons or Compton electrons, or ionized electrons are directly generated in gases in the drift-acceleration region using incident charged particles, in step ST2; a second step which is performed such that the ionized electrons generated in the first step are accelerated and amplified in internal filling gases of a hole of a gas electron multiplier through an electron avalanche effect to form electron clouds, in step ST3, and signals of the electron clouds are extracted, in step ST4; and a third step which is performed such that the extracted signals of the second step are analyzed, in step ST5, and then image information of the inside and outside of the target object is outputted thereto in a planar image format, in step ST 6.

The second step is performed such that the ionized electrons in the drift-acceleration region are accelerated by a gas electron multiplication unit 120 and then amplified in the internal filling gas of the hole of the GEM by the electron avalanche effect, using the GEM, to form electron clouds, in step ST3, and electric signals are extracted by an output electrode 133 of a readout 130 from the electron clouds in an induction region formed in the gas electron multiplication unit 120, in step ST4.

As mentioned above, the following is a description for operations of the array gas electron multiplier (GEM) digital imaging radiation detector according to the present invention and of the control method thereof, with reference to the attached drawings. Firstly, the present invention can be properly used as a security search apparatus in a harbor or an airport, or can be adapted as a core part of industrial nondestructive testing apparatus. As ionized electrons of internal filling gas are multiplied as a gas electron multiplier (GEM) generates an electron avalanche effect in the hole thereof, in which the ionized electrons are generated as a photo-electron effect or a Compton effect is induced by high energy incident light, such as X-rays or gamma rays, or ionized electrons are directly generated by incident charged particles. Afterwards, image information of the inside or outside of a target object is converted into images of two-dimensions, in real time. More specifically, the array gas electron multiplier (GEM) digital imaging radiation detector is described in detail with reference to FIG. 1 and FIG. 6. FIG. 1 illustrates a block diagram of an array GEM digital imaging radiation detector according to one embodiment of the present invention, and FIG. 6 illustrates a block diagram of the array GEM digital imaging radiation detector including the array GEM of FIG. 1.

As shown in the drawings, the array GEM detector 100 of the array GEM digital imaging radiation detector can be configured to include an ionized electron gas generation unit 110 and a gas electron multiplication unit 120. The array GEM detector 100 may further include 200 a radiation input unit 200, a translation unit 300, an analysis unit 400 and a displaying unit 500.

The ionized electron generation unit 110 is configured to include an incident window 111 and a first spacer 115, in which the incident window 111 includes a transparent window 112 and a cathode 113.

The ionized electron generation unit 110 serves to generate ionized electrons in internal filling gas by incident X-rays or gamma rays or directly generate ionized electrons in internal filling gas by incident charged particles as X-rays or gamma rays incident to the array GEM detector 100 are converted to photo-electrons or Compton electrons. The ionized electron generation unit 110 is configured such that a transparent window 112 is formed as materials, such as quartz or Mylar or G-10 or flexy glass, in which the materials can transmit or screen X-rays or gamma rays or charged particles to comply with detection objective, and a cathode 113 is adjacently formed on one side of the transparent window 112 as electrode materials having high conductivity are coated on the one side, in which the electrode may include one or more materials of gold, aluminum, copper, silver and platinum.

Here, the electrode materials are evaporated on the transparent window 112 to form the cathode 113 using a sputtering or a pulsed laser deposition, or coated to the transparent window 112 by a plating method.

On the other hand, the gas electron multiplication unit 120 may be configured to include one or more than one gas electron multipliers (GEM). As shown in FIG. 2, the gas electron multiplication unit 120 according to the embodiment of the present invention is implemented with two GEMs, however, it may be implemented with one GEM or three GEMs. Furthermore, the present invention can be implemented with the GEM and the spacers whose numbers are variable. For example, if one GEM is used, one spacer must be employed for forming a spacer therefor; if two GEMs are used, two spacers must be employed for forming a spacer for each GEM and if three GEMs are used, three spacers must be employed for forming a spacer for each GEM, and so on. The following is a description for a case where the present invention is implemented with two GEMs.

FIG. 3 illustrates a perspective view of the gas electron multiplication unit of FIG. 1. More specifically, FIG. 3 shows an embodiment of a GEM foil. Here, a technology of the GEM employs a simple concept of electromagnetics The phenomena generated in the ionized electron generation unit 110 and the array GEM detector 100 are described below: photo-electrons or Compton electrons are ionized, in which the photo-electrons or the Compton electrons are converted from high energy photons as the high energy photons are incident to the array GEM detector 100 as a GEM detector is mutually operated with the incident window 111 or the transparent window 112 or materials of the cathode 113; or photo-electrons or Compton electrons are ionized, in which the photo-electrons or the Compton electrons are converted from middle energy photons as the middle energy photons are incident to the array GEM detector 100 as a GEM detector is mutually operated with gases filled in the drift-acceleration regions inside of the first spacer 115; or gases filled in the drift-acceleration region inside the first spacer 115 are ionized as charged particles or photons are incident to the array GEM detector 100 as a GEM detector. Here, the positive ions are slowly moved to the cathode 113 by potential difference between the cathode 113 and the gas electron multiplication units 121 and 123, and the electrons are rapidly moved to the output electrode 133 of the readout 130 located at the lower end of the gas electron multiplication units 121 and 123. Here, since the weight of an electron is 1/2000 times lighter than that of a positive ion, the speed of the electron is 100 times faster than that of the positive ion when applying a voltage to the electrodes.

FIG. 4 illustrates a perspective view of the array GEM detector of FIG. 1, and FIG. 5 illustrates a cross-sectional view of the array GEM detector of FIG. 1. As shown in the drawings, each of the first and second gas electron multiplication units 121 and 123 employs a GEM foil (GF) along whose length three to five holes are aligned.

The ionized electrons are rapidly accelerated to the hole of the GEM foil by electric fields (>10⁴V/cm) which are densely formed by a geometrical structure of the first and second gas electron multiplication units 121 and 123. Here, the ionized electrons are generated in filling gases in the drift-acceleration regions by the photo-electrons or the Compton electrons which are converted in the ionized electron generation unit 110 or directly generated in filling gases in the drift-acceleration regions by the incident charged particles. Afterwards, electrons are detected, in which the electrons are generated by an electron avalanche effect which multiplies the ionized electrons to become thousands of times as many as the ionized electrons are rapidly collided with the gases in the GEM foil, or light simultaneously emitted while the electron avalanche effect occurs is detected, such that positions of electron clouds in the drift-acceleration region, a drift-induction region, or an induction region, and time information are measured at a high resolution.

Also, the photo-electrons or the Compton electrons, which are emitted from the cathode 113 in a solid state or the drift-acceleration region, or the ionized electrons, which are ionized in the drift-acceleration region by the incident charged particles, are drawn into the hole of the GEM foil of the first gas electron multiplication unit 121 and then multiplied. After that, the electrons from the first gas electron multiplication unit 121 are sequentially multiplied through the second gas electron multiplication unit 123 as a next GEM in order to obtain a relatively large effective gain.

Here, when a single GEM is used, the electron clouds are formed by the first gas electron multiplication unit 123 such that they can be used in the readout 130. In addition, the readout 130 according to the present invention can be implemented by use of a micro printed circuit board (MPCB), etc., to obtain two-dimensional position information (x, y) of electrical pulse signals for multiplied electrons.

On the other hand, electrons can be removed from gases in the drift-acceleration region whose interval is 1 mm as the photo-electrons or the Compton electrons are accelerated when a voltage of 500˜2000V is applied between the cathode 113 and the first gas electron multiplication unit 121, since minimum ionization energy of a gas is approximately 10˜20 eV and average generation energy of generating an electron-ion pair of a gas is approximately 30 eV. Afterwards, the number of the electrons can be approximately calculated using a Bethe-Bloch formula and a Landau distribution formula. When the electron avalanche effect is induced through the GEM hole, an effective gain of approximately 10⁵ can be obtained. The electron clouds (or electron beam) can be converted to electrical signals and then digitalized in the readout 130, such that digital images can be displayed in real time on a screen of a computer or a proper display device.

The first gas electron multiplication unit 121 inputs ionized electrons, which are generated in the filling gases inside the drift-acceleration region by photons or Compton electrons, which are converted in the drift-acceleration region of the ionized electron generation unit 110, or multiplies ionized electrons in the filling gases at the GEM hole through an electron avalanche effect by using the GEM, in which the ionized electrons are generated in the filling gases inside the drift-acceleration region by the incident charged particles. Therefore, the first gas electron multiplication unit 121 is configured such that a gas must be selected to comply with a wavelength of light to be detected and the cathode 113 which is coated and located inside the ionized electron generation unit 110. Also, the ionized electrons, which are generated in the filling gases inside the drift-acceleration region by incident photo-electrons or Compton electrons which are accelerated in the first gas electron multiplication unit 121, or ionized electrons, which are directly ionized in the filling gases inside the drift-acceleration region by the incident charged particles, induce an electron avalanche effect in the GEM hole to ionize the gases, thereby increasing the number of the electrons.

Such a first gas electron multiplication unit 121 can be configured such that it is spaced apart from the ionized electron generation unit 110 with an interval of 0.1˜10 mm, preferably 0.1˜3 mm. To this end, a first spacer 115 is used therein. Therefore, as the thickness of the first spacer 115 is changed, the interval between the incident window 111 of the ionized electron generation unit 110 and the first gas electron multiplication unit 121 is adjusted, thereby adjusting size of the drift-acceleration region. Also, the first gas multiplication unit 121 inputs a voltage of 100˜10,000V, preferably 500˜2,000V.

Therefore, when the gas to comply with the light wavelength and the coated cathode 113 is selected, a voltage of 500˜2,000V is applied to the drift-acceleration region (which can be manufactured at an interval of 0.1˜2 mm), in which the drift-acceleration region is between the ionized electron generation unit 110 and the foil of the gas electron multiplication unit 120. Therefore, the first gas electron multiplication unit 121 attracts the ionized electrons such that the attracted ionized electrons can be multiplied in the GEM hole through the electron avalanche effect.

Here, before the ionized primary gases (inert gases) collide with the cathode 113, they collide with some quenching gas, such that they can be changed to neutral gases and the quenching gas (organic multi-atom gas) can be ionized by energy generated from change of the ionized primary gases to neutral gases. After that, the ionized gases collide with the cathode 113 to couple with free electrons, and then return to the their original states with suppression of ultra-violet emission (namely, when an excited state is changed to a ground state, as energy is emitted as a type of vibration or decomposition, such that emission of ultra-violet rays, which results from the emission of energy, can be checked). Simultaneously, in an ionization process or a successive ionization by ultra-violet rays, which are generated inside the array GEM detector 100 in a collision with the cathode 113, gas is split into individual molecules. Therefore, considering a proper gas not generating discharge (which is a Penning effect) and a gas which can increase a gain and has a long life span, and a ratio of mixture between the gases, a gas, whose response time is short as a time resolution is increased, fills the drift-acceleration region, which is formed by the first spacer 115 of the array GEM detector 100, at a certain pressure, such that the gas can be used as an ionized gas or a quenching gas.

Considering characteristics of the array GEM detector 100, the voltage applied to the detector must be carefully selected in a proportional coefficient range. Also, the second gas electron multiplication unit 123 further accelerates the electrons multiplied by the first gas electron multiplication unit 121 and re-multiplies the number of electrons with a certain magnifying power in the GEM hole through an electron avalanche effect. Such a second gas electron multiplication unit 123 inputs a voltage of 100˜10,000V, preferably, 500˜2,000V.

Here, the second gas electron multiplication unit 123 is spaced apart from the first gas electron multiplication unit 121 at an interval of 0.1˜10 mm, preferably, 0.1˜2 mm. To this end, a second spacer 122 is used therein. Therefore, as the thickness of the second spacer 122 is changed, the interval between the first gas electron multiplication unit 121 and the second gas electron multiplication unit 123 is adjusted, thereby adjusting size of the drift-induction region.

Therefore, as the second gas electron multiplication unit 123 inputs a voltage of 500˜2,000V, ionized electrons, which are ionized by the photo-electrons or the Compton electron in the drift-acceleration region, are accelerated to the hole of GEM foil. Here, the number of electrons are multiplied by 10³˜10⁴ times through the electron avalanche effect. Also, the electrons can be further multiplied by 10˜10⁶. Here, the GEM layer functions like a capacitor by a Kapton (polyimide) disposed between copper films.

In addition, the second gas electron multiplication unit 123 is spaced apart from the readout 130 at an interval of 0.1˜10 mm, preferably, 0.1˜2 mm. To this end, a third spacer 124 is used therein. Therefore, as the thickness of the third spacer 124, the interval between the second gas electron multiplication 123 and the charge killer 131 of the readout 130, is adjusted, the size of the induction region is also adjusted.

Here, since the multiplication degree, etc., is dependent on the interval between the layers, optimum conditions must be found while the interval between the GEMs is changed by 0.1˜2 mm. On the other hand, the detector is designed such that, while the interval between the second gas electron multiplication unit 123 and the readout 130 is changed by 0.1˜2 mm, the spatial resolution is checked according to the interval change, and optimum conditions based on the interval between the layers are found.

As described above, the gas electron multiplication unit 120 may be configured by only the first gas electron multiplication unit 121, as a single GEM, and the second spacer 122, except for the second gas electron multiplication unit 123 and the third spacer 124. Also, the gas electron multiplication unit 120 may be configured by more than three GEMs and spacers.

On the other hand, the readout 130 inputs the electron clouds as electrical signals, in which the electron clouds are multiplied in the gas electron multiplication unit 120, and converts the inputted electrical signals to one-dimensional coordinates to output them.

Such a readout 130 is implemented with a MPCB. The readout 130 includes a charge killer 131, an isolator 132, an output electrode 133, and a supporter 134. The supporter 134 is manufactured by materials, such as glass, G-10, epoxy, phenolic resin, etc. The charge killer 131 is configured such that a single coating is performed with a high conduction material.

Also, the charge killer 131 is connected to the ground such that electrons falling on the outside of the readout 130 can be rapidly discharged. These unnecessary electrons are rapidly removed to increase a signal-to-noise ratio (S/N) of signals.

In addition, the isolator 132 serves to isolate the charge killer 131 and the output electrode 133 to restrict a spatial region on which electron clouds generating signals fall, thereby improving a spatial resolution of signals.

Therefore, the charge killer 131 can remove the electron clouds which are proper as signals, although the electron clouds are multiplied in the gas electron multiplication unit 120. The charge killer 131 is configured such that an isolator 132 is single-coated with a material having good conductivity.

Also, the isolator 132 serves to isolate the charge killer 131 and the output electrode 133. The isolator 132 employs a Mylar film as a material whose surface resistance is relatively large or a material similar to polyimide (Kapton) and is configured such that its thickness is 10˜100 μm. Preferably, the thickness of the isolator 132 is 50 μm such that it can properly provide isolation.

Also, the output electrode 133 outputs electrical signals corresponding to the electron clouds which are multiplied in the gas electron multiplication unit 120. Therefore, as the readout 130 inputs electrical signals corresponding to the electron clouds multiplied in the gas electron multiplication unit 120 through the MPCB, planar coordinates of the target object translated by the translation unit 300 can be found.

Also, the MPCB of the readout 130 can be manufactured as a type of array as fine linear electrodes are evenly and lengthwise aligned. In addition, the readout 130 can be configured by adopting an applicable specific integrated circuit (ASIC) output technology or a delay line output MPCB. Also, the readout 130 can be configured to manufacture another readout device, such that screens P20, P22 and P46, etc., which are doped with phosphor or fluorescence instead of PCB, are coupled to a CCD camera. As ultra-violet rays or visible rays, which are emitted when an electron avalanche occurs in the GEM holes, are detected, images for incident light can be acquired. Here, the wavelength of the emitted light is determined by the gas the rein. Also, the readout 130 can be configured by ASIC readout electronics, Resistive Anode Readout Electronics, Pad or Strip Anode Electronics, Delay-line Anode Readout Electronics, Micro-strip Gas Chamber (MSGC) readout electronics, Scintillation readout electronics, etc. By one of the above, the readout 130 can be configured to perform its detection objective. The analog signals detected by the above method are converted to digital signals by an analog-to-digital conversion (ADC).

However, when the readout 130 is configured with scintillation materials or fluorescence or phosphor, it is difficult to acquire digital two-dimensional information of the incident light. Therefore, a small amount of scintillation materials are used to form a read out of a type of array such that two-dimensional information can be acquired. Here, scintillation material must be machined to form a fine pixel such that a resolution of micro units can be obtained.

A micro-channel capillary plate according to another embodiment of the present invention may be used therefor. However, since the micro-channel capillary plate has disadvantages in that it cannot be manufactured on a large scale and is easily fragile, such problems must be dealt with when the detector is configured.

A step (electron multiplication) of light-light-electron-electrical signals is separated in two ways using the photo multiplier tube (PMT). However, when the readout 130 is configured using the MPCB, since all procedures are performed within the relatively thin thickness (5˜20 mm) thereof, planar information of the incident radiation can be extracted at a relatively high resolution. Here, when measuring energy, the interval between the electron generation unit 110 and the first gas electron multiplication unit 121 is relatively small to form a Landau distribution. Therefore, the measurement mechanism according to the Bethe-Bloch formula must be reviewed in detail and then such a problem can be dealt with thereby.

On the other hand, the array GEM detector 100 may be housed to form a rectangular pipe. Also, the array GEM detector 100 may be housed to form various forms. More specifically, the array GEM detector 100 is housed such that, while outer walls are formed by the first spacer 115, second spacer 122 and third spacer 124, the ionized electron generation unit 110, the gas electron multiplication unit 120, and the readout 130 are coupled to each other as each contact surface among the gas electron multiplication unit 120, and the readout 130 is coated with binder and then contacted to each other. Also, primary and quenching gases for ionization are filled in the drift-acceleration region which is formed by the first spacer 115. Here, the gases are processed by one of a gas sealing fashion or a gas injection-discharge fashion. Namely, the gas sealing fashion seals gases therein and the gas injection-discharge fashion is to inject and discharge gases therein/therefrom as needed. Also, the drift-induction region and the induction region must be filled with the same gases filling the drift acceleration region of the first spacer 115. Therefore, the array GEM detector 100 is formed as a part whose dimensions, width (10˜300 mm)×length (1˜5 mm)×height (5˜10 mm), are such that it can be inserted thereto like a chip when it is used.

Therefore, when the incident radiation is X-rays (whose energy is less than 100 keV), the array GEM detector 100 performs detection in which the X-rays are mainly reacted with gases in the drift-acceleration region and detected by the photoelectric effect and the Compton effect. On the other hand, when the incident radiation is gamma rays (whose energy is greater than 100 keV), the photoelectric effect and the Compton effect are generated in the incident window 111 or the transparent window 112 or the cathode 113 of a thin film, which are coated with copper, gold, platinum, aluminum or a combination thereof. However, the effects occur rarely in the gases since a collision cross-sectional area by the photoelectric effect and the Compton effect of gases is small. Therefore, the gamma rays are detected in the incident window 111 or the transparent window 112 and the cathode 113. Here, the principle where the ionized electrons are multiplied in the hole of the GEM foil is identically applied to the X-rays and the gamma rays. Also, when charged particles are incident, gases filling the drift-acceleration region between the cathode 113 and the first gas electron multiplication unit 121 are directly ionized and then detected. Also, since the drift-acceleration region is thin, the energy loss distribution of the incident radiation follows Landau distribution.

On the other hand, the array GEM digital imaging radiation detector may be configured to further include a radiation input unit 200 and a translation unit 300, as shown in FIG. 6 and FIG. 7. Here, the radiation input unit 200 projects incident light, such as X-rays or gamma rays or incident radiation of a charged particle beam to a target object, such that the array GEM detector 100 can detect the incident light or the incident charged particles.

The translation unit 300 translates a target object such that the X-rays or gamma rays or the charged particle beam can penetrate the target object to be transmitted to the array gas electron multiplication unit 100. The translation unit 300 may be installed in places, such as an airport, a harbor, etc., to acquire planar images inside and outside the target object. Also, the translation unit 300 can be implemented with a conventional conveyor belt system, etc.

The array GEM detector 100 can inevitably obtain one-dimensional information when it reads signals in a state where it was installed thereto. On the other hand, while the target object is translated by the translation unit 300 at a certain speed in a state where the array GEM detector 100 is fixed to a position, the array GEM detector 100 successively reads signals and sequentially outputs them, thereby obtaining two-dimensional images.

On the other hand, the array GEM digital imaging radiation detector may further include an analysis unit 400, as shown in FIG. 6 and FIG. 8. The analysis unit 400 includes a data acquisition unit 410 and a personal computer 490 such that the electrical signals outputted from the array gas electron multiplication unit 100 can analyzed and then image information of the inside and outside of the target object to form two-dimensional images can be reconfigured.

Here, the data acquisition unit 410 inputs and analyzes the electrical signals outputted from the array gas electron multiplication unit 100 according to magnitudes of the electrical signals, in which the data acquisition unit 410 is implemented with a Data Acquisition (DAQ) card. The personal computer 490 re-configures planar information of the target object based on two-dimensional image using the information analyzed in the data acquisition unit 410.

Also, as shown in FIG. 9, the data acquisition unit 410 includes a controller 420, a primary channel processing unit 430, a multiplexer 440, and a fast AD converter 450. In addition, it may further include a dummy channel processing unit 460, a test pulse generator 470 and a test channel processing unit 480.

The controller 420 controls operations of the data acquisition unit 410, and also controls the primary channel processing unit 430, the multiplexer 440, and the fast AD converter 450, the dummy channel processing unit 460, the test pulse generator 470 and a test channel processing unit 480, such that the data acquisition unit 410 can input and analyze electrical signals outputted from the readout 130 according to the magnitudes of the electrical signals.

The primary channel processing unit 430 performs a primary channel process for the electrical signals outputted from the array gas electron multiplication unit 100, and classifies the processed electrical signals based on magnitudes of the electrical signals, detects energy distribution of incident radiation, such as incident X-rays, or incident gamma rays, or incident charged particles, and then outputs the result. Here, the primary channel may be configured to include hundreds of channels or thousands of channels according to resolutions of detection images.

The primary channel processing unit 430 includes a pre-amplifier 431, a shaper 432, a buffer 433, a pipeline 434, and a primary-amplifier 435. The pre-amplifier 431 amplifies the electrical signals having a relatively small magnitude, which are outputted from the output electrode 133 of the readout 130. Here, when a voltage is applied to the gas electron multiplication unit 120, the electrons arrived at the output electrode 133 of the readout 130 such that electrical signals can be extracted from the output electrode 133. The electrical signals outputted from the output electrode 133 appear as a voltage. Here, since the magnitude of the electrical signals from the output electrode 133 is small, the pre-amplifier 431 serves to pre-amplify the weak electrical signals.

The shaper 432 serves to remove noises in the signals amplified in the preamplifier 431 and to perform selection of amplitudes thereof, thereby performing reconfiguration of pulse shapes. The buffer 433 stores the output of the shaper 432 in charge amounts corresponding to the output, in which the charge amounts are proportional to the intensity of the signals.

The pipeline 434 classifies the electrical signals stored in the buffer 433, detects energy distribution of incident radiation and then outputs them. The primary-amplifier 435 amplifies the output of the pipeline 434 to transmit it to the multiplexer 440.

Here, the buffer 433, the pipeline 434 and the primary amplifier 435 are implemented with double correlated sampling circuits (DCSC), respectively. Also, the multiplexer 440 multiplexes the outputs of the primary channel processing unit 430 and outputs the multiplexed result.

The fast AD converter 450 performs fast analog to digital conversion for the output of the multiplexer 440 and outputs the converted result. Namely, as the fast AD converter 450 coverts the analog signals outputted from the multiplexer 440 into digital signals, it is easy to perform data acquisition and storage and to process information.

The pre-amplifier 431, the shaper 432, the buffer 433, the pipeline 434, the primary-amplifier 435, and the multiplexer 440 and the fast AD converter 450 must be synchronously operated together depending on time. To this end, each element uses a synchronous timing signal, which is generated by a chip of an ASIC design, such as a field programmable gate array (FPGA). Also, the digital signals converted in the fast AD converter 450 are stored in an external memory (not shown) or directly transmitted to the personal computer 490.

Also, the dummy channel process unit 460 and the test channel process unit 480 can be configured to dummy channel and test channel, respectively. The dummy channel process unit 460 includes a pre-amplifier 461, a buffer 462, a pipeline 463, a primary-amplifier 464. The test channel process unit 480 includes a pre-amplifier 481, a shaper 482, a buffer 482, a pipeline 484, a primary-amplifier 485. Therefore, the electrical signals inputted in the array GEM detector 100 are transmitted to the data acquisition unit 410 of a DAQ card to store information of two-dimensional coordinates to form data. The data is transmitted to the personal computer 490 such that the computer 490 can perform image processing in real time.

Also, the DAQ card may further include a front-end bias generator, an inter-integrated circuit interface, a backend bias generator, etc. Also, the array GEM digital imaging radiation detector may further include a displaying unit 500 for displaying data, stored in the data acquisition unit 410, in the form of a DAQ card, thereon, as shown in FIG. 6 and FIG. 10. The displaying unit 500 serves to display images for the data based on density distribution thereof, in which the images are produced as a computer program performs color processing for the data which is obtained, stored and accumulated by a computer program. To this end, the displaying unit 500 can be implemented with a printer 510, a plotter 520, a computer screen 530, a liquid crystal screen, etc.

Also, the array GEM detector 100 is manufactured as a single part to be connected to the analysis unit 400 and the displaying unit 500. Therefore, when the array GEM detector 500 is worn out, only the detector 500 needs to be replaced with new one.

As described above, the present invention can multiply ionized electrons of internal filling gas as a gas electron multiplier (GEM) generates an electron avalanche effect in the hole thereof, in which the ionized electrons are generated as a photo-electron effect or a Compton effect is induced by high energy incident light, such as X-rays or gamma rays, or which are directly generated by incident charged particles, and convert image information of the inside or outside of a target object into images of two-dimensions, in real time, such that the detector can be properly used as a security search apparatus in a harbor or an airport, or can be adapted as a core part of industrial nondestructive testing apparatus.

Although a few embodiments of the present invention have been shown and described, it would be appreciated by those skilled in the art that changes may be made in these embodiments without departing from the principles and spirit of the invention, the scope of which is defined in the claims and their equivalents.

1. An array gas electron multiplier (GEM) digital imaging radiation detector comprising an array GEM detector, wherein the array GEM detector comprises:
an ionized electron generation unit for generating ionized electrons in internal filling gas by incident X-rays or gamma rays or for directly generating ionized electrons in internal filling gas by incident charged particles;
a gas electron multiplication unit for multiplying the ionized electrons of the ionized electron generation unit in filling gas inside hole of a gas electron multiplier (GEM), through electron avalanche effect, using the GEM, to form electron clouds; and
a readout for detecting and outputting coordinates of the electron clouds as the readout receives positions through electrical signals, in which the positions of the electron clouds, being multiplied and formed in the gas electron multiplication unit, reach output electrodes.

2. The array GEM digital imaging radiation detector as set forth in claim 1, wherein the ionized electron generation unit includes:
an incident window which converts incident gamma rays into photoelectrons or Compton electrons or receives incident X-rays or incident charged particles; and
a first spacer which is located between the first window and the gas electron multiplication unit, wherein the first spacer forms a drift-acceleration region which converts the incident X-rays or gamma rays into photo-electrons or Compton electrons and generates ionized electrons in the internal filling gas using the converted photo-electrons or Compton electrons, or directly generates ionized electrons in the internal filling gas using the incident charged particles, and is filled with primary gas and buffer gas, which are mixed with a certain ratio, at a certain pressure therein.

3. The array GEM digital imaging radiation detector as set forth in claim 2, wherein the incident window includes:
a transparent window for penetrating or screening the incident X-rays or gamma rays according to detection objective of the incident X-rays or gamma rays; and
a cathode which is coated with an electrode material such that incident radiation transmitted to the incident window can reach thereto.

4. The array GEM digital imaging radiation detector as set forth in claim 3, wherein the cathode is coated with one or more than one electrode materials of gold, aluminum, copper, silver and platinum.

5. The array GEM digital imaging radiation detector as set forth in claim 4, wherein the cathode is coated with the electrode materials at a thickness of 5˜30 μm.

6. The array GEM digital imaging radiation detector as set forth in claim 1, wherein the gas electron multiplication unit includes one or more than two gas electron multipliers (GEM).

7. The array GEM digital imaging radiation detector as set forth in claim 1, wherein the gas electron multiplication unit includes:
a first gas electron multiplication unit which accelerates electrons ionized in gases in the drift-acceleration region, in which the ionized electrons are converted in the ionized electron generation unit, and multiplies the number of electrons in gases filled in the hole of the GEM with a certain ratio using an electron avalanche effect; and
a second spacer which is located between the first gas electron multiplication unit and the readout, such that the second spacer forms an induction region and is filled with primary gas and buffer gas, which are mixed with a certain ratio, at a certain pressure therein.

8. The array GEM digital imaging radiation detector as set forth in claim 1, wherein the gas electron multiplication unit includes:
a first gas electron multiplication unit which accelerates electrons ionized in gases in the drift-acceleration region, in which the ionized electrons are converted in the ionized electron generation unit, and multiplies the number of electrons in gases filled in the hole of the GEM with a certain ratio using an electron avalanche effect;
a second spacer which is located between the first gas electron multiplication unit and a readout, such that the second spacer forms an induction regions;
a second gas electron multiplication unit which re-multiplies the number of electrons, which are multiplied in the first gas electron multiplication unit, in gases filled in the hole of the GEM with a certain ratio using an electron avalanche effect, to form electron clouds; and
a third spacer which is located between the second gas electron multiplication unit and a readout, which forms an induction region and is filled with primary gas and buffer gas, which are mixed with a certain ratio, at a certain pressure therein.

9. The array GEM digital imaging radiation detector as set forth in claim 8, wherein each of the first and second gas electron multiplication units includes 3˜5 holes which are aligned along the length direction.

10. The array GEM digital imaging radiation detector as set forth in claim 1, wherein the readout includes:
a charge killer removing noise except for the electron clouds multiplied in the gas electron multiplication unit;
an isolator which isolates the charge killer and an output electrode such that a spatial region of the electron clouds can be restricted and a spatial resolution of signal can be increased;
an output electrode for transmitting electrical signals of the electron clouds, which pass through the charge killer and the isolator, to the outside of the readout; and
a supporting unit for supporting the readout.

11. The array GEM digital imaging radiation detector as set forth in claim 10, wherein the charge killer is coated with a single high conduction material.

12. The array GEM digital imaging radiation detector as set forth in claim 10, wherein the charge killer is coated with a single conduction material at the edge of the output electrode such that noise can be removed except for the electron clouds multiplied in the gas electron multiplication unit.

13. The array GEM digital imaging radiation detector as set forth in claim 10, wherein the charge killer is connected to the ground.

14. The array GEM digital imaging radiation detector as set forth in claim 1, further comprising:
a radiation input unit for projecting incident radiation, such as, X-rays or gamma rays or charged particles to a target object; and
a translation unit for translating the target object such that the incident radiation of the radiation input unit can penetrate the target object to be transmitted to the array gas electron multiplication unit.

15. The array GEM digital imaging radiation detector as set forth in claim 1, further comprising:
an analysis unit which analyzes the electrical signals outputted from the array gas electron multiplication unit and reconfigures image information of the inside and outside of the target object to form two-dimensional images.

16. The array GEM digital imaging radiation detector as set forth in claim 15, wherein the analysis unit includes:
a data acquisition unit which inputs and analyzes the electrical signals outputted from the array gas electron multiplication unit according to magnitudes of the electrical signals, in which the data acquisition unit is implemented with a data acquisition (DAQ) card; and
a personal computer which re-configures the information of the inside and outside of the target object, which is acquired in the data acquisition unit, to form a planar image.

17. The array GEM digital imaging radiation detector as set forth in claim 16, wherein the data acquisition unit includes:
a controller for controlling operations of the data acquisition unit;
a primary channel processing unit which performs a primary channel process for the electrical signals outputted from the array gas electron multiplication unit, and classifies the processed electrical signals based on magnitudes of the electrical signals, detects energy distribution of incident radiation, and then output the result;
a multiplexer for multiplexing the outputs of the primary channel processing unit and outputting the multiplexed result; and
a fast AD converter for performing analog to digital conversion for the output of the multiplexer and outputting the converted result.

18. The array GEM digital imaging radiation detector as set forth in claim 17, wherein the primary channel processing unit includes:
a pre-amplifier for amplifying the electrical signals outputted from the array GEM detector;
a shaper for performing reconfiguration of pulse shapes for the amplified signals of the pre-amplifier;
a buffer for storing the output of the shaper;
a pipeline for classifying the electrical signals stored in the buffer, detecting energy distribution of incident radiation and then outputting them;
a primary-amplifier for amplifying the output of the pipeline to transmit it to the multiplexer.

19. The array GEM digital imaging radiation detector as set forth in claim 17, wherein the data acquisition unit further includes a dummy channel processing unit, in which the dummy channel processing unit includes:
a pre-amplifier for amplifying electrical signals inputted to a dummy channel;
a buffer for storing the output of the pre-amplifier;
a pipeline for classifying the electrical signals stored in the buffer, detecting energy distribution of incident radiations and then outputting them; and
a primary-amplifier for amplifying the output of the pipeline to transmit it to the multiplexer.

20. The array GEM digital imaging radiation detector as set forth in claim 17, wherein the data acquisition unit further includes a test pulse generator for generating a test pulse and a test channel processing unit,
wherein the test channel processing unit includes:
a pre-amplifier for inputting the test pulse from the test pulse generator and amplifying it;
a shaper for performing reconfiguration of pulse shapes for the amplified signals of the pre-amplifier;
a buffer for storing the output of the shaper;
a pipeline for classifying the electrical signals stored in the buffer, detecting energy distribution of incident radiation and then outputting them;
a primary-amplifier for amplifying the output of the pipeline and transmitting the amplified result to the multiplexer.

21. The array GEM digital imaging radiation detector as set forth in claim 15, wherein the array gas electron multiplier (GEM) digital imaging radiation detector further includes a displaying unit for outputting image information of the inside and outside of the target object in a two-dimensional image format thereto, in which the image information is reconfigured on the basis of the signals outputted from the analysis unit,
wherein the displaying unit is implemented with one or more than one of a printer, a plotter, a computer screen, and an LC screen.

22. A method of controlling an array GEM digital imaging radiation detector comprising:
a first step which is performed such that, when X-rays or gamma rays or charged particles are projected to a target object which is translated by a translation unit, the X-rays or gamma rays, which are projected to a cathode of an ionized electron generation unit or a drift-acceleration region, are converted into photo-electrons or Compton electrons, and ionized electrons are generated in gases in the drift-acceleration region using the converted photo-electrons or Compton electrons, or ionized electrons are directly generated in gases in the drift-acceleration region using incident charged particles;
a second step which is performed such that the ionized electrons generated in the first step are accelerated and amplified in internal filling gases of a hole of a gas electron multiplier through an electron avalanche effect to form electron clouds, and signals of the electron clouds are extracted; and
a third step which is performed such that the extracted signals of the second step are analyzed, and then image information of the inside and outside of the target object is outputted thereto in a planar image format.

23. The method as set forth in claim 22, wherein the second step includes:
forming electron clouds, as the ionized electrons in the drift-acceleration region are accelerated by a gas electron multiplication unit and then amplified in the internal filling gas of the hole of the GEM by the electron avalanche effect, using the GEM; and
extracting electric signals in an output electrode of a readout from the electron clouds in induction region formed in the gas electron multiplication unit.
